(19) United States
(12) Patent Application Publication
(10) Pub. No.: US 2008/0165250 A1
(43) Pub. Date: Jul. 10, 2008

(54) Vehicle security surveillance system

(76) Inventors: Jeff Kirk Ekdahl, San Antonio, TX (US); Jason Charles McIntyre, San Antonio, TX (US)

Correspondence Address: Jason McIntyre, 16100 Henderson Pass, # 607, San Antonio, TX, 78232, US

(21) Appl. No.: 11/650,607

(22) Filed: Jan. 8, 2007

(51) Int. Cl. H04N 7/18

(52) U.S. Cl. 348/148; 348/E07.087; 340/937

(57) ABSTRACT

This is a vehicle security surveillance system (VS3). The VS3 system can either use a color CCD camera or black/white CCD camera with a motion detector built in. The camera will have a micro hard drive attached to it. The miniature hard drive will have software programmed into it such that when the motion detector is activated it will send power to the drive, which in turn activates the software. Once the software is activated it will store the images with a time and date stamp. The vehicle surveillance system will be constructed in one single unit. Each unit will be small enough to install in one or more locations in the vehicle as long as there is a power supply available.

### RELATED APPLICATIONS

The present application is related to U.S. Pat. No. 7,015,828B2, issued Mar. 21, 2006, for VEHICLE MONITORING APPARATUS, included by reference herein.

The present application is related to U.S. Pat. No. 7,027,616B2, issued Apr. 11, 2006, for MONITORING SYSTEM, included by reference herein.

The present application is related to U.S. Pat. No. 7,106,365B1, issued Sep. 12, 2006, included by reference herein.

The present application is related to U.S. Pat. No. 7,061,405B2, issued Jun. 13, 2006, included by reference herein.

The present application is related to U.S. Pat. No. 5,978,017, issued Nov. 2, 1999, included by reference herein.

The present application is related to U.S. Pat. No. 7,050,089B2, issued May 23, 2006, for ON-VEHICLE VIDEO CAMERA, included by reference herein.

The present application is related to U.S. Pat. No. 7,100,190B2, issued Aug. 29, 2006, included by reference herein.

The present application is related to U.S. Pat. No. 7,111,968B2, issued Sep. 26, 2006, included by reference herein.

The present application is related to U.S. Pat. No. 7,064,657B2, issued Jun. 20, 2006, included by reference herein.

The present application is related to U.S. Pat. No. 6,717,511B2, issued Apr. 6, 2004, included by reference herein.

The present application is related to U.S. Pat. No. 7,110,021B2, issued Sep. 19, 2006, included by reference herein.

The present application is related to U.S. Pat. No. 7,091,833B1, issued Aug. 15, 2006, included by reference herein.

The present application is related to U.S. patent number WO 2005/041581 A1, issued Oct. 19, 2006, included by reference herein.

### FIELD OF THE INVENTION

The present invention relates to the vehicle security and, more particularly, to a vehicle security system that captures digital images.

### BACKGROUND OF THE INVENTION

This vehicle surveillance system is a revolutionary new product for the automotive security market. The inspiration for this device evolved from the growing problem that has been overlooked for many years concerning vehicle vandalism and burglaries. These types of crimes are the most difficult to solve due to limited or the lack of evidence and lack of valid eyewitnesses. This vehicle surveillance system does solve this problem through its' many features and capabilities to record and monitor your vehicle. The evidence that this vehicle surveillance system provides can be an invaluable source of evidence for use by insurance companies, policing agencies, and any court of law.

This device will provide the highest level of protection possible against vehicle vandalism and burglaries in comparison to existing vehicle protection systems. This device can serve as a supplement to existing and new vehicle protection system packages. This device provides the most reliable deterrent in the event of a potential vehicle vandalism or burglary. This device has the potential of preventing the vandalism or theft from even occurring. This device also provides the most reliable evidence in the event of an actual vehicle vandalism or burglary. This innovate product will revolutionize the vehicle security industry.

The advantages of this vehicle surveillance system will help in stopping vehicles from being burglarized. For example, in San Antonio, Tex., there were 24,986-vehicle burglaries in 2004. This is just one set of data from a large metropolitan city and you could just image how many vehicles are burglarized every year through out the United States. The Dallas, Tex. police chief Ralph Mendoza said, “Most of these BMVs are committed by criminals who are breaking into dozens of cars a month. Vehicle burglaries cost Fort Worth residents over $5 million in stolen property every year. In addition, it costs victims in terms of inconvenience, repairing broken windows and doors, as well as increased insurance rates.” The Waco police department reported 33,986 Burglarized motor vehicles (BMV) for a period of 10 years, from 1194 to 2004.

Summary of Data

Location Stats

San Antonio, Tex. 24,986 BMW's in 2004

Dallas, Tex. $5 Million lost in 2004

Waco, Tex. 33,986 BMV's in a 11 year period

Table 1—Summary of BMV data

This system will help in assisting the Police by providing them proof of the criminal (s) who burglarized someones vehicle. With this type of system it will also help to reduce the number of claims against insurance companys, help to reduce insurance premiums, and help reduce the out of pocket expenses, like deductibles, for people that have this system installed in their vehicle.

There are currently no other vehicle security products on the market that are similar to the vehicle security surveillance system (VS3).

Currently vehicle security systems are predominately designed to alert bystanders that a vehicle is being burglarized. These types of vehicle alarm systems are unreliable for several reasons like, they can be set too sensitive, no one pays attention to an activated alarm, and the police usually do not investigate these types of vehicle burglaries. The current alarms can be set so sensitive that when someone closes their car door next to a vehicle with this type of vehicle alarm system, this action will cause the alarm to activate. Another reason these types of vehicle alarm systems are not good is because they do not deter thefts. Also, people do not pay attention to an activated vehicle alarm. Finally, the police usually do not investigate these types of crimes because it is usually requires a lot of effort and time from the police agency and usually with very little evident's.

Therefore, no device has been created to fulfill the need for capturing digital images of people burglarizing a vehicle that can be given to the police as evidences of a crime (s). In prior vehicle alarm systems, they have never had the capability to record and store digital images on a hard drive built into a camera. Nor has any prior vehicle alarm system addressed the combination of a digital camera with a software built-in as one single unit to allow the vehicle owner to remove the camera (s) to download the images. This VS3 system will allow a vehicle owner to have multiple cameras in several location independent of each other.

It is therefore an object of the invention to provide a surveillance security system for vehicles.

It is another object of the invention to digitally record images either frame by frame or in a video and the images can in black/white of color.

It is another object of the invention to time and date stamp all digital files.

It is another object of the invention to store encrypted digital images for downloading and giving it to the police.

It is another object of the invention to reduce insurance cost by detouring potential break-ins.

### SUMMARY OF THE INVENTION

In accordance with the present invention, there is provided a vehicle security surveillance system. A color or black/white miniature camera with a motion detector built in will have a miniature hard drive attached to it. The miniature hard drive will have software programmed into it such that when the motion detectors are activated it sends power to the drive, which in turn activates the software. The vehicle surveillance system will be constructed in a single unit. Each unit will be small enough to install in one or more locations in the vehicle as long as there is a power supply available.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a back seat view of a this is the view of one location that the camera could be placed;

FIG. 2 is a driver side view of a different view of the camera in the drivers side “a” frame;

FIG. 3 is a passenger side view of a view of the camera installed in the drivers side “a” frame;

FIG. 4 is a sample of camera design view of a this is a conceptual view of what the camera could look like;

FIG. 5 is a side view of a this is a typical view of the ccd camera from the side. the usb in this view can be folded up when in the vehicle and unfolded for downloading of the files; and

FIG. 6 is a top view of a this is a view looking down of the camera system.

For purposes of clarity and brevity, like elements and components will bear the same designations and numbering throughout the Figures.

### DESCRIPTION OF THE PREFERRED EMBODIMENT

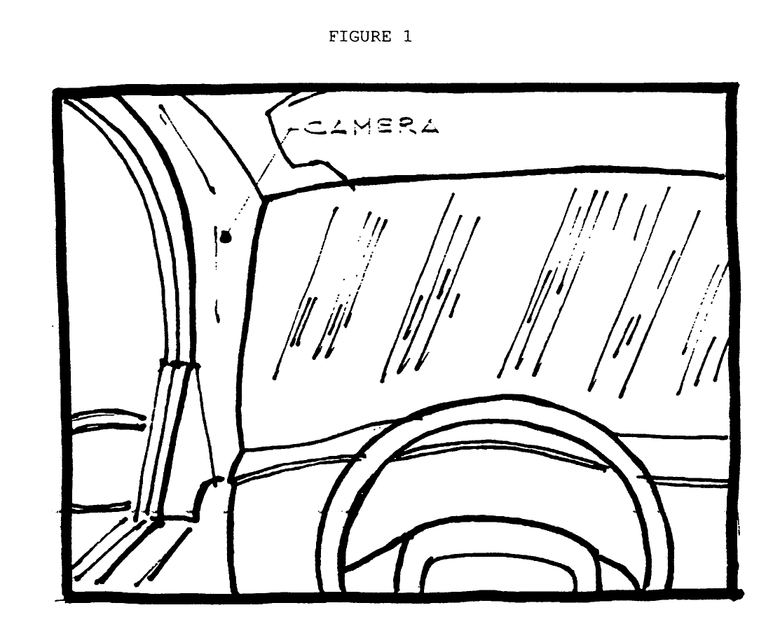

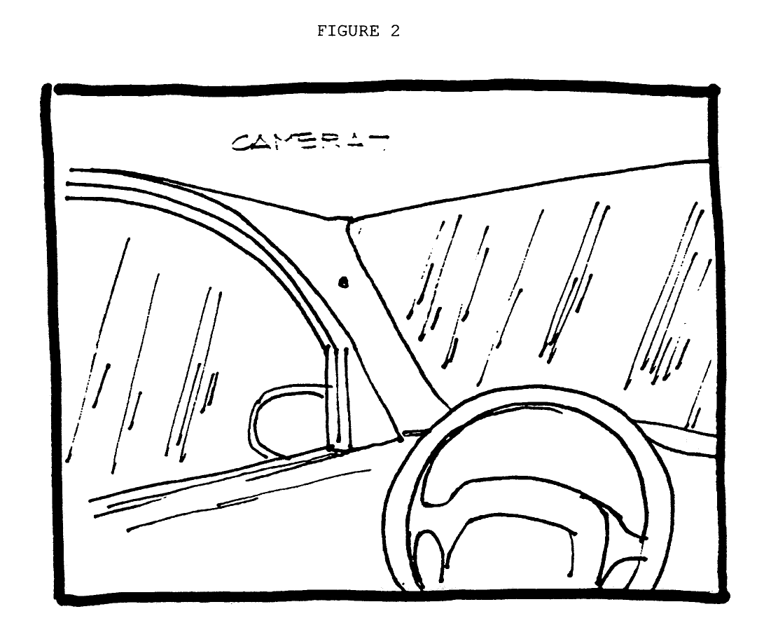

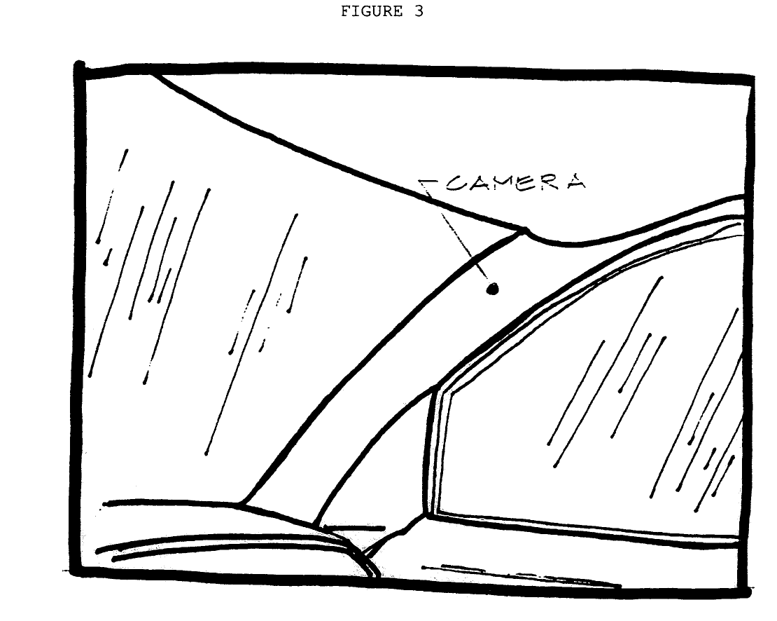

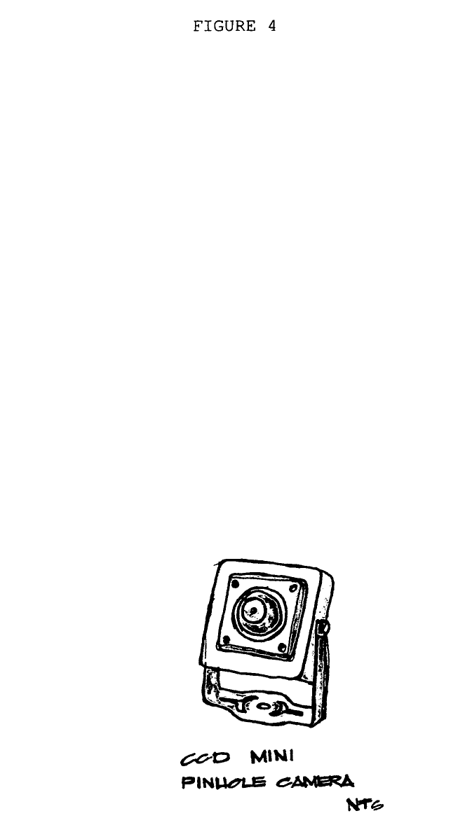

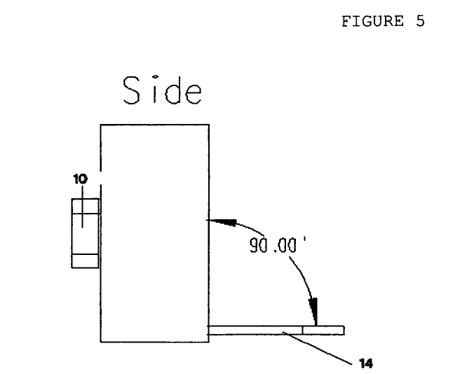

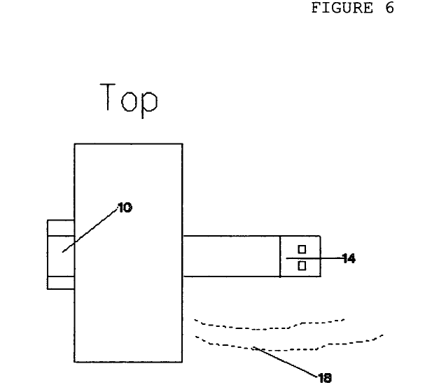

This system is designed to record vehicle burglaries. VS3 will monitor the vehicle while it is in stationary position, in the off position. The system will be in stand-by mode while the vehicle is parked and only will activate and start recording images when the motion sensor and/or shock sensors are triggered. The camera that will be used is the charged-coupled device (CCD) with built in motion sensors and built in memory. The CCD cameras 10 will have the option to use one camera or multiple cameras since they will operate independently of each other. The VS3 system will have the option of placing CCD cameras 10 in several different locations depending on the type of vehicles (car, truck, SUV). When this security system is installed into a passenger car and truck, the CCD cameras 10 can be located in the dash, driver side “A” frame, FIG. 1 and FIG. 2, passenger side “A” frame, FIG. 3, dome light, and/or truck. The VS3 can be installed at the factory with a built-in camera placed at the automotive manufactures preference. The aftermarket system will have the option to be packaged such that the consumer can install the security system packages in desired locations. When this security system is installed into SUV type of vehicles, a second camera can be installed halfway back (at the dome light) to catch a burglar breaking into the rear of the vehicle or through the side doors on the vehicle. This security system can be placed anywhere in the vehicle as long as a Power Supply 20 is connected to the Wiring 18 on the CCD camera. The CCD cameras 10 will have built in motion detector and/or motion sensors. Once the sensor is activated, the CCD cameras 10 will activate and will start to digitally record the images with a time and date stamp on the image(s). The digitally recorded images will record on to an Micro Hard Drive 12 that will be built-in to each camera separately, FIG. 4. The Micro Hard Drive 12 will work like a flash drive, such that when there is no power supplied to the Micro Hard Drive 12 it will still have all the data saved to its memory. The Software 16 will record and store digital files on each CCD camera in a folder and time/date stamp each file. Each Folder will have a preset number of subfolders where it can store the digital files. Once all subfolders are completely full, the program will delete the contents of the oldest subfolder and then record the next file in that subfolder. This self-cleaning program will ensure that there will always be an empty subfolder available to record any possible attempts to burglarize the vehicle. Downloading the images from VS3 will be accomplished in several of different ways. One way is to install a USB plug 14 on an spring load reel, FIG. 5. That way the camera can remain in place and the USB plug 14 can be pulled out and connected to a laptop computer for downloading the recorded images and updates to the Software 16. The second option will allow the consumer to remove the camera from the vehicle and connect it to a desk top computer or laptop for downloading the recorded images and Software 16 updates, FIG. 6. The files will have the option of remaining on the Micro Hard Drive 12 or the best option is to delete them once downloaded. The images will be encrypted so that the file can not be tampered with. Encrypted files will greatly increase the chances of getting a guilty verdict in the legal system.

This security system will also operate while the vehicle is in the on position to record activity that occurs inside of the vehicle. The system will be activated by a button or an encoded valet key that can be turned on/off by the vehicle owner before handing the vehicle over to the valet or service attendant. In the on position the system will monitor all activity inside of the vehicle by camera to record the contents left behind, snooping, theft, and driving habits of the valet or service attendant. The system will deactivate once the vehicle ignition has been turned off and the valet or service attendant has exited the vehicle and shut the door. Once this has occurred the security system will go into a shut down mode after the door is closed, which allows the cameras and recording system to monitor and sense motion inside of the vehicle for approximately two minutes to ensure the absence of activity and ensure vehicle contents. This security system will have the option to connect one camera with a valet switch.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A vehicle security surveillance system for vehicle security to reduce vehicle burglary's and insurance claims, comprising:
means for the camera will be used to capture color digital images of the person(s) breaking into your vehicle. the camera can either be color or black/white. the camera with also have motion detection built in to it;
means for this micro hard drive will be used to store the digital images for storing images and for downloading of the files, rigidly embedded to said means for the camera will be used to capture color digital images of the person(s) breaking into your vehicle. the camera can either be color or black/white. the camera with also have motion detection built in to it;
means for the usb port will be used to transfer the secure files between the camera and a computer system, rigidly interconnected to said means for this micro hard drive will be used to store the digital images for storing images and for downloading of the files;
means for the software will activate when the camera (s) motion detectors are activated and will store the images digitally. the software will also have the capability of self cleaning old files, rigidly embedded to said means for this micro hard drive will be used to store the digital images for storing images and for downloading of the files; and
means for wiring will be needed to supply power to the camera system. the system will require a positive (+) wire and a negative (−) wire, rigidly connected to said means for this micro hard drive will be used to store the digital images for storing images and for downloading of the files.

2. The vehicle security surveillance system in accordance with claim 1, wherein said means for the camera will be used to capture color digital images of the person(s) breaking into your vehicle. the camera can either be color or black/white. the camera with also have motion detection built in to it comprises a color or black/white, motion detector ccd cameras.

3. The vehicle security surveillance system in accordance with claim 1, wherein said means for this micro hard drive will be used to store the digital images for storing images and for downloading of the files comprises a micro hard drive.

4. The vehicle security surveillance system in accordance with claim 1, wherein said means for the usb port will be used to transfer the secure files between the camera and a computer system comprises an usb plug.

5. The vehicle security surveillance system in accordance with claim 1, wherein said means for the software will activate when the camera (s) motion detectors are activated and will store the images digitally. the software will also have the capability of self cleaning old files comprises software.

6. The vehicle security surveillance system in accordance with claim 1, wherein said means for wiring will be needed to supply power to the camera system. the system will require a positive (+) wire and a negative (−) wire comprises a wiring.

7. A vehicle security surveillance system for vehicle security to reduce vehicle burglary's and insurance claims, comprising:
a color or black/white, motion detector ccd cameras, for the camera will be used to capture color digital images of the person(s) breaking into your vehicle. the camera can either be color or black/white. the camera with also have motion detection built in to it;
a micro hard drive, for this micro hard drive will be used to store the digital images for storing images and for downloading of the files, rigidly embedded to said CCD cameras;
an usb plug, for the usb port will be used to transfer the secure files between the camera and a computer system, rigidly interconnected to said Micro Hard Drive;
software, for the software will activate when the camera (s) motion detectors are activated and will store the images digitally. the software will also have the capability of self cleaning old files, rigidly embedded to said Micro Hard Drive; and
a wiring, for wiring will be needed to supply power to the camera system. the system will require a positive (+) wire and a negative (−) wire, rigidly connected to said Micro Hard Drive.

8. A vehicle security surveillance system for vehicle security to reduce vehicle burglary's and insurance claims, comprising:
a color or black/white, motion detector ccd cameras, for the camera will be used to capture color digital images of the person(s) breaking into your vehicle. the camera can either be color or black/white. the camera with also have motion detection built in to it;
a micro hard drive, for this micro hard drive will be used to store the digital images for storing images and for downloading of the files, rigidly embedded to said CCD cameras;
an usb plug, for the usb port will be used to transfer the secure files between the camera and a computer system, rigidly interconnected to said Micro Hard Drive;
software, for the software will activate when the camera (s) motion detectors are activated and will store the images digitally. the software will also have the capability of self cleaning old files, rigidly embedded to said Micro Hard Drive; and
a wiring, for wiring will be needed to supply power to the camera system. the system will require a positive (+) wire and a negative (−) wire, rigidly connected to said Micro Hard Drive.
